(19) United States
(12) Patent Application Publication
(10) Pub. No.: US 2025/0296496 A1
(43) Pub. Date: Sep. 25, 2025

(54) AUTO SLIDE

(71) Applicant: Wayne M. Chechak, Portersville, PA (US)

(72) Inventor: Wayne M. Chechak, Portersville, PA (US)

(21) Appl. No.: 19/078,552

(22) Filed: Mar. 13, 2025

Related U.S. Application Data
(60) Provisional application No. 63/567,572, filed on Mar. 20, 2024.

(51) Int. Cl. B60P 3/12; B60P 1/04; B60P 1/64

(52) U.S. Cl. CPC B60P 3/122; B60P 1/6409; B60P 1/04

(57) ABSTRACT

An auto slide includes a body having a wheel well defined in the body. The wheel well can be sized to retain a wheel of a vehicle (e.g. a tire of the wheel). The body of the auto slide can be sized and configured for attachment of the wheel to the body of the auto slide. After attachment of the wheel to the auto slide, the vehicle can be pulled along the ground and onto a tilted trailer or truck bed for transportation of the vehicle.

### CROSS-REFERENCE TO RELATED APPLICATIONS

This application claims priority to U.S. Provisional Patent Application No. 63/567,572, which was filed on Mar. 20, 2024. The entirety of this provisional patent application is incorporated by reference herein.

### FIELD

This invention relates to a device that can be utilized in sets of two or more devices. The device can be attached to front wheels, back wheels or all four wheels of a disabled automobile (e.g. car, truck, sport utility vehicle (SUV), etc.) that must be towed to a repair shop or other location and the method of using the set of devices to help load and unload the disabled vehicle onto or from a Rollback Tow Truck or a trailer. Some embodiments can also be adapted for transport of other vehicles that may have other sets of wheels (e.g. a three axle vehicle having six or more wheels).

### BACKGROUND

Currently there are “skates” available that are small wedge type plastic structures that need to be hammered under the tires of a car or the car must be lifted and set on skates to pull the car onto a truck bed. I have found these products to be difficult to use and not the best solution. They easily get caught on the edge of the truck bed while pulling the car onto the truck bed. Also, with the skates positioned under the tires, the wedge-shape of the skates can make it difficult to move the vehicles when being pulled or pushed onto a bed of a truck for transport.

Also, I have found that conventional towing that involves pulling or pushing a car onto a truck bed (often via a truck bed mounted winch) can result in low profile vehicles becoming damaged during the pulling of pushing of the car onto a truck bed. For example, when the car reaches the rear edge of the bed of the truck, the low profile of a car can result in the underside of the car significantly contacting with the lower part of the bed of the truck in a way that can damage the underside of the car.

### SUMMARY

I believe that there is currently a need for a device that can be easily placed under a wheel of a car, particularly a wheel that is locked and will not turn, and will enable the vehicle to easily slide on concrete, asphalt, aluminum, steel, gravel, grass, dirt and other surfaces on or near the location where a vehicle is disabled. Embodiments of my auto slide device can be used to assist disabled vehicles (e.g. cars, trucks, SUVs, etc.) stuck in park, have locked wheels and/or have wheels with the steering locked for loading onto a truck bed or offloading from the truck bed (e.g. a trailer or a truck bed of a tow truck, etc.). Embodiments can also be configured to facilitate vehicle sliding on multi-surfaces, which can eliminate the need to attach cables, straps, or chains to vehicle suspensions located on the frame of the vehicle at different attachments points.

In some embodiments, an auto slide can include a body comprised of metal and/or a polymeric material. The body can have a front, a rear opposite the front, a left side that extends between the rear and the front and a right side that extends between the rear and the front opposite the left side to define a wheel well. The wheel well can be sized and configured to retain a wheel of a vehicle so that the body is positionable between the wheel of the vehicle and ground.

The left, right, front and rear can be configured to define holes to facilitate utilization of straps or bands for securing a wheel within the wheel well. The body can be configured to have ribs on the bottom of the body there can be ribs attached to a bottom of the body below the wheel well in some embodiments. The ribs can be configured to directly contact the ground so that the ribs are between the wheel well and the ground to facilitate sliding of the auto slide along the ground while a wheel is secured to the body and held within the wheel well.

In some embodiments, the body is comprised of plastic. In other embodiments, the body can be comprised of metal, a composite material, an alloy, or other suitable material or combination of materials. In embodiments that utilize ribs, the ribs can be comprised of metal, a polymeric material, plastic, or other suitable material. In some embodiments, the ribs can be fastened to the bottom of the body via fasteners. In other embodiments, the ribs can be defined on the bottom of the body and be integral to the bottom of the body (e.g. via molding of the body to have the ribs on the bottom, etc.).

An assembly of auto slides is also provided. The assembly of auto slides can include two or more auto slides. For example, an assembly can include a first auto slide for a front right wheel of a vehicle and a second auto slide for a front left wheel of a vehicle. As another example, the assembly can include a first auto slide for a rear right wheel of a vehicle and a second auto slide for a rear left wheel of a vehicle. As yet another example, the assembly can include a first auto slide for a front right wheel of a vehicle, a second auto slide for a front left wheel of a vehicle, a third auto slide for a rear right wheel of a vehicle and a fourth auto slide for a rear left wheel of a vehicle.

A method of towing a vehicle is also provided. Embodiments of the method can include attaching a first auto slide to a first wheel of the vehicle such that the first wheel is positioned in a wheel well of the first auto slide and a bottom of the first auto slide is between the first wheel and ground on which the vehicle is positioned, attaching a second auto slide to a second wheel of the vehicle such that the second wheel is positioned in a wheel well of the second auto slide and a bottom of the second auto slide is between the second wheel and the ground, coupling the first and second auto slides to a winch of a tow truck, actuating the winch to pull the vehicle onto a bed or trailer of the tow truck, and transporting the vehicle to a pre-selected location after the vehicle is on the bed or trailer of the tow truck.

In some embodiments, the method can also include tilting the trailer or the bed of the tow truck for pulling vehicle onto the bed or the trailer and subsequently adjusting a position of the trailer for transportation of the vehicle on the trailer or the bed of the two truck. For example, the method can include adjusting the trailer or the bed into a horizontal orientation after the vehicle is pulled onto the bed or the trailer.

Embodiments of the method can also include other steps or features. For instance, the method can also include pulling the vehicle onto the bed or the trailer of the tow truck such that the ribs of the first auto slide and the ribs of the second auto slide contact the ground while the vehicle is being pulled onto the trailer or the bed. As another example, embodiments can include passing straps through holes in the front, rear, left side, and/or right side of each the first auto slide for securing the wheel within the wheel well of the first auto slide. As another example, embodiments can include passing straps through holes in the front, rear, left side, and/or right side of each the second auto slide for securing the wheel within the wheel well of the second auto slide.

Other details, objects, and advantages of the auto slide, assembly of auto slides, method of towing a vehicle, and methods of making and using the same will become apparent as the following description of certain exemplary embodiments thereof proceeds.

### BRIEF DESCRIPTION OF THE DRAWINGS

Exemplary embodiments of my auto slide device and methods of making and using the same can be appreciated from the drawings. Like reference numbers can refer to like components.

FIG. 1 is a side view of a first exemplary embodiment of my auto slide 1 attached to wheel(s) 3 of a vehicle 5.

FIG. 2 is a side view of the first exemplary embodiment of my auto slide 1 attached to a wheel 3 of a vehicle 5.

FIG. 3 is a perspective view of the first exemplary embodiment of my auto slide 1.

FIG. 4 is a side view of the first exemplary embodiment of my auto slide.

FIG. 5 is a bottom view of the first exemplary embodiment of my auto slide 1.

FIG. 6 is a top perspective view of the first exemplary embodiment of my auto slide 1.

FIG. 7 is a flow chart illustrating a first exemplary embodiment of a method of using my auto slide 1.

### DETAILED DESCRIPTION

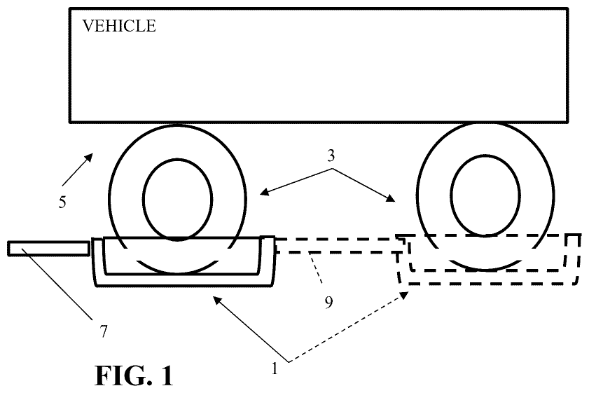

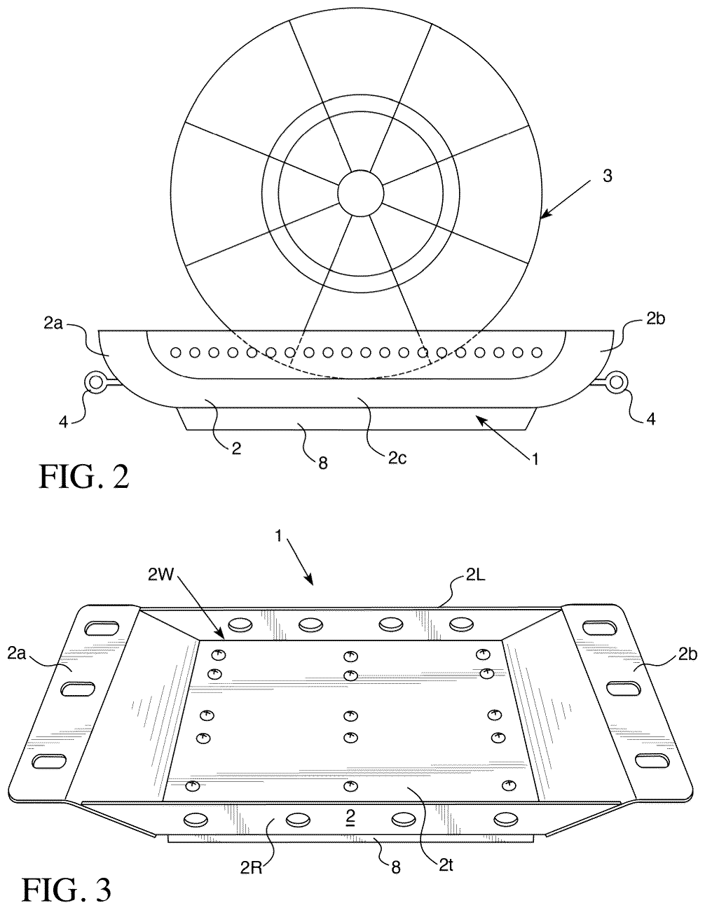

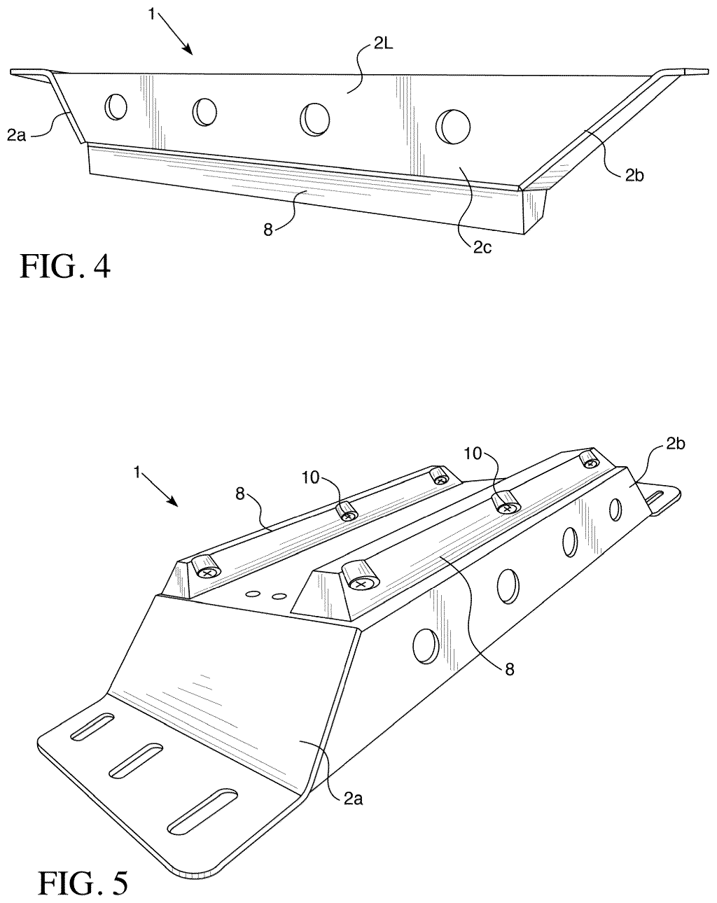

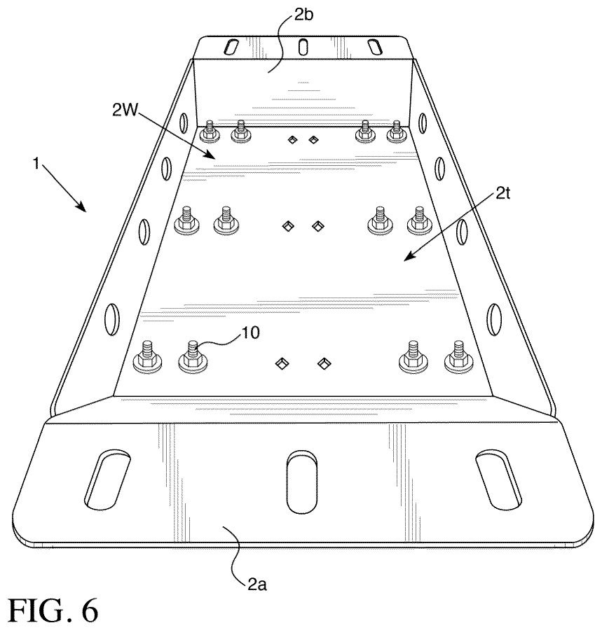

Referring to FIG. 1 through FIG. 6, embodiments of the auto slide can be configured so that each auto slide 1 can retain a wheel 3 so that the auto slide can be pulled to drag a vehicle along the ground and onto a tilted flat bed of a truck (e.g. a Rollback Tow Truck) or a trailer of a truck. Embodiments can be utilized so that there are multiple auto slides 1 used for different wheels 3 of a vehicle 5.

For example, for a front wheel drive vehicle, there can be a first auto slide 1 that retains the front left wheel 3 and a second auto slide 1 that retains the front right wheel. As another example, for a rear wheel drive vehicle, there can be a first auto slide 1 that retains the rear left wheel 3 and a second auto slide 1 that retains the rear right wheel. In yet other embodiments, there can be an auto slide for reach respective wheel. For example, there can be a first auto slide 1 for the front right wheel, a second auto slide 1 for the front left wheel, a third auto slide 1 for the rear right wheel and a fourth auto slide for the left rear wheel for a vehicle that may have four wheels. Such an approach can be utilized for four wheel drive vehicles or all-wheel drive vehicles, for example.

After the auto slides 1 are positioned to retain the appropriate wheels 3, the body 2 of the auto slides can be positioned between the ground and the wheel that the auto slide 1 retains. An elongated member 7 can be coupled to the vehicle 5 (e.g. to a portion of a frame of the vehicle). The elongated member 7 can be coupled to a spool or other mechanism that can be powered to rotate or move to retract the elongated member 7 to drag or pull the vehicle 5 along the ground via the auto slides 1 onto a tilted trailer of a truck. Once the vehicle's wheels are all on the trailer, the trailer may then be tilted into a more horizontal orientation for transportation of the vehicle. In some embodiments, the elongated member 7 can be coupled to a winch that may be actuated to pull a vehicle to which the elongated member(s) 7 are attached to position the vehicle onto a trailer or bed of a truck for transportation of the vehicle 5 (e.g. towing of the vehicle 5).

In some embodiments, there can be a connector 9 extending between different auto slides 1 so that when the elongated member 7 is moved to pull a vehicle, the force is conveyed to the other auto slides 1 via the connector 9 so the vehicle can be more uniformly moved. Other embodiments may not need utilization of such a connector 9 due to the weight of the vehicle 5 and the force exerted by the elongated member 7 on the front auto slides 1.

In some embodiments, the elongated members 7 can extend between a coupling device and the front-most auto slides 1. Such a coupling device can couple the front auto slides together via elongated members 7 that may extend from the more central coupling device. A towing member can be connected to that central coupling device for pulling the vehicle 5 onto the trailer or bed of a truck. The force of the pulling may be more uniformly transferred to the different auto slides 1 via the elongated members 7 being connected to a more central coupling device positioned between the towing member and the elongated members 7. The towing member can be a cable, wire, rope, or other type of elongated member that can be extended from a winch of the truck and retracted onto a winch in some embodiments.

Each auto slide can have a body 2. The body can be comprised of metal (e.g. steel) and/or polymeric material. In some embodiments, the body 2 can be entirely metal or entirely plastic for example. For instance, in some embodiments, the body 2 can be comprised of a polymeric material and the body 2 can be formed via an injection molding machine. In other embodiments, the body 2 can be formed via fastening different components together to form the body 2.

In other embodiments, the body 2 can be metal and plastic or include some metal parts and some polymeric parts. Also, the body 2 can include one or more ribs 8 or have one or more ribs 8 positioned on the bottom 2c of the body 2. In some embodiments, the one or more ribs 8 can be another type of material (e.g. a different type of plastic, a different type of metal, an elastomeric material, etc.).

As may best be seen from FIG. 3 through FIG. 6, the body 2 of each auto slide 1 can have a front 2a, a rear 2b opposite the front 2a, a left side 2L that extends between the front 2a and the rear 2b, and a right side 2R that extends between the front 2a and the rear 2b. The body 2 can also include a bottom 2c that extends from the bottom of the front 2a to the bottom of the rear 2b and also extends from the bottom of the right side 2R to a bottom of the left side 2L.

The front 2a, rear 2b, left side 2L, right side 2R, bottom 2c and top 2t can be configured to define a wheel well 2W in the upper surface or top surface of the body 2. The wheel well 2W can be a recess or channel sized to retain a wheel 3 on the top 2t of the body 2 so that the bottom 2c of the body 2 can contact the ground and be positioned between the wheel 3 that is retained in the wheel well 2W and the ground.

The left side 2L and right side 2R can each include a sidewall that extend between the front 2a and the rear 2b of the body 2. The front 2a and the rear 2b can each include a side wall that extends between the left side 2L and the right side 2R. For instance, the front 2a can extend between the front of the left side 2L and the front of the right side 2R and the rear 2b can extend between the rear of the left side 2L and the rear of the right side 2R. The front, rear, left side 2L and right side 2R can be defined to provide a wheel well 2W that is sized to retain a vehicle wheel.

A wheel can be positioned in the wheel well by using a jack to raise the wheel 3 off the ground, sliding the auto slide 1 under the wheel so that the wheel is positioned within the wheel well 2W, and subsequently lowering the wheel onto the auto slide 1 via use of the jack to lower the wheel. In some types of situations, it is contemplated that a sufficient number of people could lift a side of a vehicle sufficiently so another person could slide an auto slide 1 under the lifted wheel 3 to position the wheel in the wheel well 2W. The people could then lower the vehicle so the wheel 3 was positioned in the wheel well 2W and in contact with the top 2t of the body 2.

In some embodiments, the body 2 can be a generally rectangular shaped body having base with a textured surface. Two parallel sides and a back wall connected between the sides can extend upward from the base to define a cavity (e.g. the wheel well 2W) that can be sized to receive a wheel 3 of a vehicle 5 to be towed. The front of the body can enclose the cavity via a front wall or can be more open so that it defines an aperture or slot to help accommodate positioning of a wheel 3 into the cavity. In some embodiments, the top 2t of the body can be defined to taper downward from a textured surface. A textured anti-skid top 2t within the cavity, or wheel well 2W, can be provided to will help with traction so the tire of the wheel 3 does not slide when positioned in the cavity, or wheel well 2W, of the auto slide 1. The body 2 can be sized to accommodate one or more types or sizes of wheel 3. Preferably embodiments of the body 2 are formed so that the wheel well 2W is large enough to accommodate most if not all sizes of vehicle tires that are desired to be towed.

In some embodiments, the body 2 can made with different heights of side walls (e.g. left side 2L, right side 2R, front 2a and/or rear 2b walls) to receive a tire ranging from a 1 inch tire seat to a 5 inch tire seat. The rear wall may be 0.75-1.0 inches thick, and 0.75-1.0 inches high to help stop a tire from sliding out of the wheel well 2W of the auto slide 1. Other embodiments may utilize other sized walls.

The body 2 can preferably be made with a strong plastic, or reinforced plastic that resists scratching. Metals, such as steel or aluminum, having sufficient strength and resistance to abrasion could also be used. A plastic body 2 can have a sufficiently thick bottom and sufficiently thick front wall and rear wall to support the weight and pressure of pulling a vehicle forward (e.g. for positioning a vehicle onto a trailer or bed of a truck) and backward (e.g. for lowering a vehicle off a tilted trailer or bed). Internal steel reinforcement can be provided in the bottom 2c and/or sidewalls of the body 2 (e.g. front 2a, rear 2b, left side 2L, and/or right side 2R) if needed.

Two or more parallel ribs 8 can be positioned along the underside, or bottom 2c, of the body 2. The ribs 8 can be positioned on a lower surface of the bottom 2c of the body 2 that is opposite the upper surface of the top 2t that can define a floor of the wheel well 2W. The ribs 8 can be configured to reduce the surface area of the auto slide 1 that is in contact with the ground (e.g. asphalt, concrete or other surface) on which the vehicle 5 is resting. This can reduce the friction that is created when the auto slide 1 carrying a vehicle's wheel 3 (e.g. tire) is pulled. Also the auto slide's footprint can allow less pressure (e.g. pounds per square inch) for soft surfaces. After two or more auto slides 1 are used so that each auto slide 1 is attached a respective wheel 3 (e.g. tire) of a vehicle 5 such that at least two wheels 3 are within wheel wells 2W of the different auto slides 1, the vehicle 5 will easily slide via actuation of a winch that can be coupled to the auto slides 1 or vehicle 3 for pulling the vehicle onto the trailer or bed of a truck.

In some embodiments, the ribs can have a pre-selected shape to help facilitate sliding of the auto slide 1 along the ground. For example, as may best be seen from FIG. 5, each rib 8 can be an elongated rail having a generally trapezoidal cross-sectional shape. The front, rear, left and right sides of the rib can be angled to provide sloped ramp surfaces. The bottom and top of each rib 8 can be flat or smooth. In some embodiments, the front and rear can have a linearly extending, smooth surface that is ramped at an angle of between 10° and 30°, 5° and 45° or other pre-selected angle. Also, the right side that can extend between the front and rear of the rib and the left side that is opposite the right side and also extends between the front and rear of the rib 8 can also be sloped at a pre-selected angle, which can be between 10° and 30°, 5° and 45°. The sloped angles of the right and left sides of the rib can provide a tapering that can occur so that the bottom of the rib 8 is wider than the top of the rib 8 and the top of the rib 8 is narrower in width than the bottom.

I prefer to provide a connector having an eyelet that extends from the front 2a of the body and a second connector that extends from the rear 2b of the body 2. The connector can be a solid steel through bolt with eye slits facing forward and backward for attachment points both to drag and tie down/secure vehicle wheels 3. In some embodiments, a connector can extend from either end of the center rib on the underside of the body and be connected to a chain or cable from a winch of a tow truck to pull the vehicle. By providing the connector on a rib, the attachment point for the elongated member 7 (e.g. a strap, cable, or chain) can be lower to provide a more sufficient clearance to front and rear low profile bumpers. This can help avoid damage to a low profile vehicle when the vehicle is moved onto a trailer or bed of a tow truck.

The auto slide 1 can be placed under a vehicle wheel 3 (e.g. tire) by lifting one end of the vehicle 3 with a tow truck or a hydraulic jack, placing the auto slide 1 under the tire and then lowering the vehicle 3. Alternatively individual wheels can be lifted by using a manual jack of the type used to change a flat tire. After the wheel 3 has been positioned on the auto slide 1, straps can be placed around the tire to secure the vehicle 3 to the auto slides. I prefer to provide several attachment holes in the front 2a, rear 2b, left side 2L and right side 2R of the body 2 of the auto slide 1 for connecting straps to the auto slide 1 for helping to attach a wheel 3 to the auto slide 1.

The sides of the body 2 may be made of plastic with steel attachment points in some embodiments, In other embodiments, each side of the body 2 that defines the wheel well 2W on which a wheel 3 can be positioned can be entirely plastic, an entirely polymeric material, or a metallic material.

In an alternative embodiment not shown in the drawings, a jack can be incorporated into the auto slide 1 or releasably attached to the auto slide 1 to raise a vehicle 3 for positioning of a wheel 3 in the wheel well 2W of the auto slide 1. Parts of the jack unit may be made of a plastic or reinforced plastic in some embodiments.

In some embodiments, the ribs 8 can be attached to a bottom surface of the bottom 2c via fasteners 10. A head of each fastener can be positioned on or in a bottom surface of a rib 8 and a terminal end of the fastener or distal end of the fastener 10 can be positioned in the wheel well 2W above the upper surface of the top 2t that defines the wheel well.

In other embodiments, the ribs 8 can be formed as integral components of the body 2 (e.g. as components of the bottom 2c). In such a configuration, fasteners 10 may not be utilized for attachment of the ribs 8 to the bottom 2c of the body 2.

Embodiment of the auto slide can be utilized in embodiments of towing a vehicle. For example, a first auto slide 1 can be attached to a first wheel 3 of the vehicle 5 such that the first wheel 3 is positioned in a wheel well 2W of the first auto slide 1 and a bottom 2c of the first auto slide 1 is between the first wheel 3 and ground on which the vehicle 5 is positioned. A second auto slide 1 can be attached to a second wheel 3 of the vehicle 5 such that the second wheel 3 is positioned in a wheel well 2W of the second auto slide 1 and a bottom 2c of the second auto slide 1 is between the second wheel 3 and the ground. The first and second auto slides 1 can be coupled to a winch of a tow truck and the winch can then be actuated to pull the vehicle 5 onto a bed or trailer of the tow truck. The ribs 8 of the auto slides 1 can contact the ground while the auto slides 1 slide along the ground as the vehicle 5 is pulled toward the bed or trailer of the truck. The vehicle 5 can subsequently be transported to a pre-selected location after the vehicle 5 is on the bed or trailer of the tow truck.

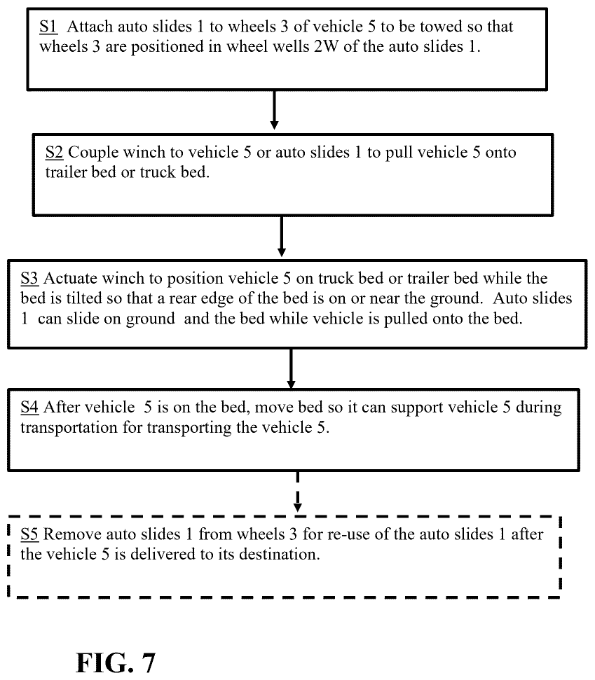

An exemplary embodiment of a method of using a plurality of auto slides 1 can also be appreciated from FIG. 7. In a first step, auto slides 1 can be attached to wheels 3 of a vehicle 5 so that the wheels are positioned in wheel wells 2W of the auto slides 1. For example, a jack or tow truck may be utilized to lift wheels for positioning them within the wheel wells 2W as noted above. The wheels 3 can then be attached to the auto slides 1 via straps or other connector elements. For each auto slide 1, the sidewalls of the body 2 of the auto slide 1 can be utilized for attachment of the wheel 3 within the wheel well 2W via straps or other connector elements as discussed above.

In a second step S2, the winch of a truck can be coupled to a vehicle 5 or auto slides 1 to pull the vehicle onto a trailer or bed of a truck. In a third step S3, the winch can be actuated to position the vehicle 5 on the trailer or bed of the truck. The trailer or bed can be tilted when the vehicle is pulled onto the trailer or bed. When in the tilted position, a rear edge of the trailer or bed can be on the ground or near the ground while the vehicle is pulled on to the trailer or bed of the truck.

In a fourth step S4, the bed or trailer can be moved after the vehicle is positioned on the trailer or bed. For instance, the bed or trailer can be tilted into a more horizontal position or into a horizontal orientation (e.g. non-tilted or much less tilted position) to facilitate transport of the vehicle 5. The vehicle can be supported on the bed or trailer for transportation. A truck can then be driven to move or tow the vehicle to a new location (e.g. a repair shop, etc.).

Some embodiments of the method can utilize other steps. For example, in a fifth step S5, the auto slides 1 can be removed from the wheels 3 of the vehicle 5 after the vehicle is taken to its new location. The removed auto slides 1 can be disposable or reusable. If the auto slides are reusable, they can be stored in the truck. if the auto slides are disposable, they can be thrown away after being used.

The removal of the auto slides 1 can include removing straps used to connect the wheels to the bodies 2 of the auto slides. The vehicle can then be lifted so that the auto slides can be separated from the tires of the wheels (e.g. a jack or other lifting mechanism may be utilized to lift the vehicle sufficiently for sliding the auto slide 1 away from the wheel 3, etc.).

It should be appreciated that embodiments of my auto slide and method for towing a vehicle and methods of making and using the auto slide can be adapted to account for a particular set of design criteria. For example, the composition of the body 2, sizing of the wheel well 2W, sizing or shape of different side walls of the front 2a, rear 2b, left side 2L, or right side 2R, thickness of the bottom 2c, and/or surface configuration of the top 2t can be adapted to account for a particular set of design criteria. It is also contemplated that a particular feature described, either individually or as part of an embodiment, can be combined with other individually described features, or parts of other embodiments. The elements and acts of the various embodiments described herein can therefore be combined to provide further embodiments. Thus, while certain exemplary embodiments of the auto slide 1, body 2, towing process, and methods of making and using the auto slides 1 have been shown and described above, it is to be distinctly understood that the invention is not limited thereto but may be otherwise variously embodied and practiced within the scope of the following claims.

What is claimed is:

1. An auto slide, comprising:
a body comprised of metal and/or a polymeric material, the body having a front, a rear opposite the front, a left side that extends between the rear and the front and a right side that extends between the rear and the front opposite the left side to define a wheel well, the wheel well is sized and configured to retain a wheel of a vehicle so that the body is positionable between the wheel of the vehicle and ground.

2. The auto slide of claim 1, wherein the body is comprised of plastic.

3. The auto slide of claim 1, wherein the auto slide includes ribs positioned on a bottom of the body, the ribs sized and configured to engage the ground.

4. The auto slide of claim 1, wherein the front and/or the rear includes holes through which straps are passable for attachment of the wheel to the body.

5. The auto slide of claim 4, wherein the left side and/or the right side includes holes through which straps are passable for attachment of the wheel to the body.

6. The auto slide of claim 1, wherein the left side and the right side includes holes through which straps are passable for attachment of the wheel to the body.

7. The auto slide of claim 6, wherein the front and the rear include holes through which straps are passable for attachment of the wheel to the body.

8. The auto slide of claim 1, comprising:
ribs positioned on a bottom of the body, the ribs sized and configured to engage the ground, the ribs being integral to the bottom of the body.

9. The auto slide of claim 1, comprising:
ribs positioned on a bottom of the body, the ribs being attached to the bottom of the body via fasteners to position the ribs on the bottom of the body to engage the ground.

10. An assembly of auto slides, comprising:
at least two auto slides of claim 1.

11. A method of towing a vehicle, comprising:
attaching a first auto slide to a first wheel of the vehicle such that the first wheel is positioned in a wheel well of the first auto slide and a bottom of the first auto slide is between the first wheel and ground on which the vehicle is positioned;
attaching a second auto slide to a second wheel of the vehicle such that the second wheel is positioned in a wheel well of the second auto slide and a bottom of the second auto slide is between the second wheel and the ground;
coupling the first and second auto slides to a winch of a tow truck;
actuating the winch to pull the vehicle onto a bed or trailer of the tow truck;
transporting the vehicle to a pre-selected location after the vehicle is on the bed or trailer of the tow truck.

12. The method of claim 11, comprising:
tilting the trailer or the bed of the tow truck for pulling vehicle onto the bed or the trailer.

13. The method of claim 12, comprising:
adjusting the trailer or the bed into a horizontal orientation after the vehicle is pulled onto the bed or the trailer.

14. The method of claim 11, wherein the first auto slide includes a body having a front, a rear opposite the front, a left side that extends between the rear and the front and a right side that extends between the rear and the front opposite the left side to define the wheel well of the first auto slide, the wheel well of the first auto slide being sized and configured to retain the first wheel of the vehicle.

15. The method of claim 14, wherein the second auto slide includes a body having a front, a rear opposite the front, a left side that extends between the rear and the front and a right side that extends between the rear and the front opposite the left side to define the wheel well of the second auto slide, the wheel well of the second auto slide being sized and configured to retain the second wheel of the vehicle.

16. The method of claim 15, wherein the body of the first auto slide is comprised of a polymeric material and the body of the second auto slide is comprised of a polymeric material.

17. The method of claim 15, wherein a bottom of the body of the first auto slide includes a plurality of ribs and a bottom of the body of the second auto slide includes a plurality of ribs.

18. The method of claim 11, wherein a bottom of a body of the first auto slide includes a plurality of ribs and a bottom of a body of the second auto slide includes a plurality of ribs.

19. The method of claim 18, comprising pulling the vehicle onto the bed or the trailer of the tow truck such that the ribs of the first auto slide and the ribs of the second auto slide contact the ground while the vehicle is being pulled onto the trailer or the bed.
